(19) United States
(12) Patent Application Publication
(10) Pub. No.: US 2024/0424896 A1
(43) Pub. Date: Dec. 26, 2024

(54) WORK VEHICLE HAVING SPEED AND/OR DISTANCE BASED DECISION SUPPORT AND INTERVENTION ZONES

(71) Applicant: Deere & Company, Moline, IL (US)

(72) Inventors: Mark J. Cherney, Bettendorf, IA (US); Joseph P. Kearney, Dubuque, IA (US)

(21) Appl. No.: 18/340,370

(22) Filed: Jun. 23, 2023

(51) Int. Cl. B60K 35/00; G06V 20/56

(52) U.S. Cl. CPC B60K 35/00; G06V 20/56; B60K 35/22; B60K 35/28; B60K 2360/167; B60K 2360/176; B60K 2360/179

(57) ABSTRACT

A computer-implemented system and method are provided for dynamically adjusting alerts based on detected objects external to a work vehicle. Vehicle-mounted object sensors generate object signals representative of detected objects in respective fields of vision, and vehicle-mounted cameras generate images corresponding to respective image regions. The images are selectively displayed, along with first indicia defining or based at least in part on concentric zones that are dynamically configured based on vehicle operating characteristics (e.g., travel speed). Distances are determined from respective object sensors to any detected objects, wherein second indicia are displayed with respect to the selectively generated images and corresponding to a respective intervention state for the objects within the images, the respective intervention state determined based on at least the determined distance and the operating characteristics of the work vehicle.

### FIELD OF THE DISCLOSURE

The present disclosure relates to self-propelled vehicles such as work vehicles having onboard obstacle detection systems, and more particularly systems and methods for supplementing conventional obstacle detection with speed- and/or distance-based decision support and intervention.

### BACKGROUND

Work vehicles as discussed herein may generally refer to self-propelled vehicles or machines including but not limited to four-wheel drive wheel loaders, excavators and other equipment which modify the terrain or equivalent working environment in some way. These self-propelled vehicles or machines may have tracked or wheeled ground engaging units supporting the undercarriage from the ground surface, and may further include one or more working implements which are used to modify the terrain in coordination with movement of the machine. Various situations arise with such self-propelled vehicles or machines where the human operator needs to control the movements of the work vehicle position and/or the relative positions of the working implements based on detected obstacles in the working area, which may or may not be visible to the operator.

Object detection systems are conventionally known to provide feedback to the operator regarding detected objects in the working area. When creating an object detection system, it is advantageous to have a system that can distinguish between different types of objects (e.g., moving or transient obstacles such as people or vehicles, or fixed obstacles such as structures or material), since the system may want to react differently to different types of objects in the environment.

Conventional object detection systems are also known which use distance-based alerts, for example capable of alerting an operator if an object is detected as being within a threshold distance from the work vehicle or a specified portion of the work vehicle.

### BRIEF SUMMARY OF THE DISCLOSURE

The current disclosure provides an enhancement to conventional systems, at least in part by providing dynamic zones for decision support and potential intervention with respect to detected objects. For example, a plurality of zones may be generated wherein alerts in a furthest zone may be masked if the work vehicle is driving slowly. One advantage of dynamic (e.g., speed-adjusted zones) is that the zones are smaller when driving slowly, resulting in fewer nuisance detections or false positives, particularly on congested construction sites which may frequently have shorter stopping distances requiring smaller alert zones.

Since braking deceleration may be assumed as constant, other operating characteristics of a work vehicle such as stopping distance, stopping time, and time to engagement with an object (e.g., collision or traverse) are all proportional to each other and linear with respect to work vehicle speed. Accordingly, alerts may be allowed to pass through to the operator based on any one or more such operating characteristics, further wherein the furthest edge of the furthest zone may be an adjustable parameter that scales with vehicle speed or related operating characteristics or parameters. A surrounding region with respect to the work vehicle may for example be broken up into multiple concentric zones that also scale linearly or non-linearly.

According to a first embodiment, a method is provided for dynamically adjusting alerts based on detected objects external to a work vehicle. Object signals are generated from one or more of a plurality of vehicle-mounted object sensors, the object signals representative of detected objects in a respective field of vision. Images are selectively generated on a display unit, the generated images corresponding to a respective image region for each of a plurality of vehicle-mounted cameras, wherein the respective field of vision for each of the plurality of object sensors overlaps with the image region for at least one of the plurality of cameras. First indicia are displayed with respect to the selectively generated images, defining or based at least in part on one or more concentric zones that are dynamically configured based on at least one operating characteristic of the work vehicle. For each object sensor, a distance is determined from the respective object sensor to any one or more of the detected objects in the respective field of vision, wherein second indicia are displayed with respect to the selectively generated images, and the displayed second indicia correspond to a respective intervention state for the any one or more of the detected objects in the respective field of vision and further within the selectively generated images, the respective intervention state determined based on at least the determined distance and the at least one operating characteristic of the work vehicle.

In one exemplary aspect according to the above-referenced embodiment, the at least one operating characteristic of the work vehicle may comprise a travelling speed of the work vehicle.

In another exemplary aspect according to the above-referenced embodiment, the at least one operating characteristic of the work vehicle may comprise a movement of a work implement moveable independently with respect to a frame of the work vehicle.

In another exemplary aspect according to the above-referenced embodiment, the at least one operating characteristic of the work vehicle may comprise an estimated stopping distance and/or stopping time.

In another exemplary aspect according to the above-referenced embodiment, the respective intervention state may correspond to an estimated time to engagement by the work vehicle with the respective detected object based on the at least determined distance and the at least one operating characteristic of the work vehicle.

For example, the respective intervention state may correspond to an estimated time to engagement by the work vehicle with the respective detected object further based on a potential movement state of the respective detected object. If the detected object is living, for example, or otherwise not necessarily static wherein there is uncertainty regarding the potential movement, the respective intervention state may correspond to an estimated time to engagement by the work vehicle with the respective detected object further based on a detected movement and/or predicted future position or predicted possible future position of the respective detected object. The displayed second indicia may further for example comprise a bounded area about the respective detected object based on the potential movement state thereof.

As another example, the respective intervention state may further correspond to a predicted response in the at least one operating characteristic of the work vehicle.

In another exemplary aspect according to the above-referenced embodiment, the method may comprise generating control signals to one or more actuators for adjusting the at least one operating characteristic of the work vehicle based on at least the respective intervention state.

In another exemplary aspect according to the above-referenced embodiment, the displayed first indicia may comprise a plurality of concentric zones, each of which are independently configured based on the at least one operating characteristic. For example, each of the plurality of concentric zones may be non-linearly scaled with respect to others of the plurality of concentric zones based on changes in travelling speed of the work vehicle over time.

In another embodiment, a work vehicle as disclosed herein includes a plurality of vehicle-mounted object sensors each configured to generate object signals representative of detected objects in a respective field of vision, a plurality of vehicle-mounted cameras each configured to generate image data corresponding to a respective image region, wherein the respective field of vision for each of the plurality of object sensors overlaps with the image region for at least one of the plurality of cameras, and a controller linked to receive the generated object signals and the generated image data. The controller may be configured to direct the performance of steps in a method according to the above-referenced embodiment and optionally any of the described aspects thereof.

In another embodiment, a system as disclosed herein includes one or more processors in communication with a plurality of vehicle-mounted object sensors each configured to generate object signals representative of detected objects in a respective field of vision, and a plurality of vehicle-mounted cameras each configured to generate image data corresponding to a respective image region, wherein the respective field of vision for each of the plurality of object sensors overlaps with the image region for at least one of the plurality of cameras. The one or more processors may be configured to direct the performance of steps in a method according to the above-referenced embodiment and optionally any of the described aspects thereof.

Numerous objects, features and advantages of the embodiments set forth herein will be readily apparent to those skilled in the art upon reading of the following disclosure when taken in conjunction with the accompanying drawings.

### BRIEF DESCRIPTION OF THE DRAWINGS

FIG. 1 is a perspective view representing an exemplary work vehicle according to the present disclosure.

FIG. 2 is a block diagram representing an exemplary control system and inputs thereto for the exemplary work vehicle according to the present disclosure.

FIGS. 3-9 are graphical diagram representing embodiments of a generated visual display to an operator of a work vehicle, including speed and/or distance adjusted indicia according to the present disclosure.

FIG. 10 is a flowchart representing an embodiment of a method according to the present disclosure.

### DETAILED DESCRIPTION

The implementations disclosed in the above drawings and the following detailed description are not intended to be exhaustive or to limit the present disclosure to these implementations.

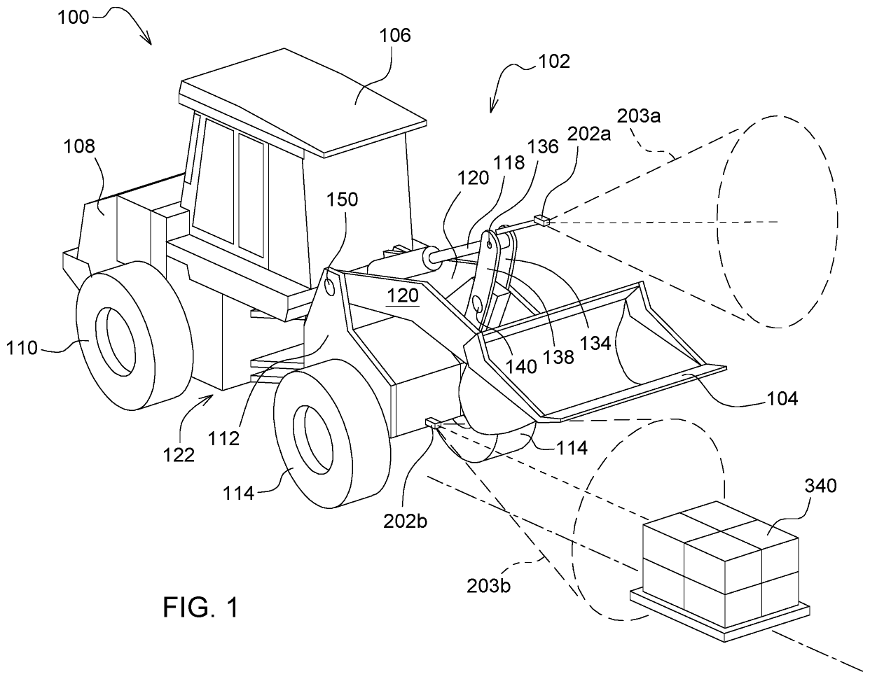

FIG. 1 in a particular embodiment as disclosed herein shows a representative work vehicle 100 in the form of, for example, a four-wheel drive loader having a front-mounted work implement 102 which includes and controllably adjusts the position of a working tool 104, such as for example a bucket which faces generally away from an operator of the work vehicle 100, for forward-scooping, carrying, and dumping dirt and other materials into a loading area such as for example a stationary bin or hopper, or a container integrated with an articulated dump truck. It is within the scope of the present disclosure that the work vehicle 100 may be in the form of various alternative equipment or vehicles, typically but not exclusively self-propelled in nature, and which may or may not include a work implement to modify the proximate terrain and/or to carry material from the terrain for loading into a loading area. Other examples of suitable working tools 104 within the scope of the present disclosure may include, without limitation, blades, pallet forks, bail lifts, augers, harvesters, tillers, mowers, grapples, and the like.

As represented in FIG. 1 the work vehicle 100 includes an operator cab 106, a rear frame portion 108 with rear ground engaging units 110 (e.g., wheels), and a front frame portion 112 with front ground engaging units 114 (e.g., wheels). The work implement 102 includes a linkage for adjusting a position of the working tool 104, and a hydraulic cylinder 118 to power the linkage. The working tool 104 is rotatably coupled to boom arms 120 at respective pivot locations 142 on opposite sides of the working tool 104. The hydraulic cylinder 118 powering the linkage and the boom arm 120 provide a boom actuator that raises and lowers the work implement 102 with respect to the frame (i.e., at least including the rear frame portion 108 and front frame portion 112 of the work vehicle 100.

An articulation joint in an embodiment may enable angular adjustment of the rear frame portion 108 with respect to the front frame portion 112. Hydraulic cylinders 122 enable angular changes between the rear and front frame portions 108 and 112 under hydraulic power derived from conventional hydraulic pumps (not shown).

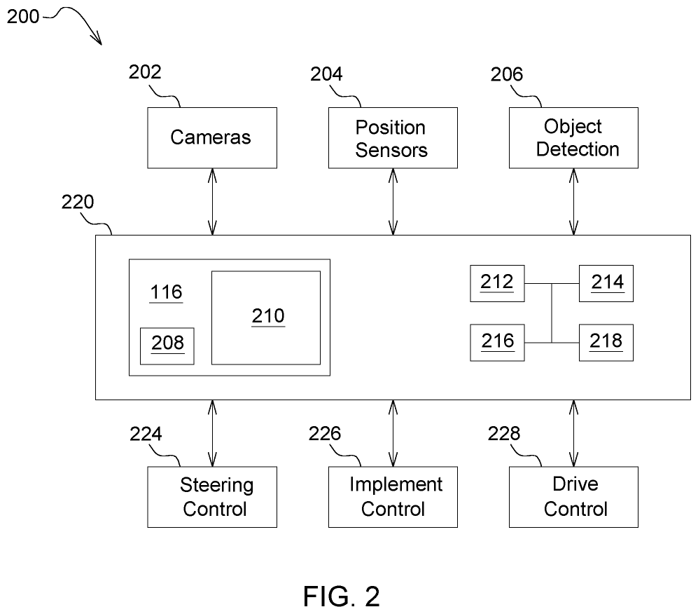

A user interface 116 (represented in FIG. 2) may be located within the operator cab 106 for use by an operator of the work vehicle 100. The user interface 116 may include or otherwise be functionally linked to one or more corresponding user interface tools 208 for input and/or output with respect to a controller 220 as further described below. Such user interface tools 208 may for example include a plurality of user selectable touch buttons (e.g., soft buttons), to select from a plurality of commands or menus, each of which may be selectable through a touch screen having a display unit 210. Touch buttons respond to touch and do not include a mechanical component requiring a force sufficient to engage mechanical features. The touch screen may be a graphical user interface configured to display icons as well as content of work vehicle applications. The display unit 210 may be configured to display in the touch screen still images, moving images, and video content through one or more different types of displays. The display unit 210 may include, but is not limited, to cathode ray tube (CRT) displays, light-emitting diode (LED) displays, and liquid crystal displays (LCD).

Such an onboard user interface 116 may be provided as part of or otherwise functionally linked to a vehicle control system 200 via for example a CAN bus arrangement or other equivalent forms of electrical and/or electro-mechanical signal transmission. Another form of user interface (not shown) may take the form of a display unit that is generated on a remote (i.e., not onboard) computing device, which may display outputs such as status indications and/or otherwise enable user interaction such as the providing of inputs to the system. In the context of a remote user interface, data transmission between for example the vehicle control system 200 and the user interface may take the form of a wireless communications system and associated components as are conventionally known in the art.

The user interface 116 may further include, or as may be as separately defined with respect to operator-accessible interface tools, an accelerator pedal which enables the operator to adjust the speed of the vehicle. In other embodiments, a hand lever provides this function. Other exemplary tools residing in or otherwise accessible from the operator cab 106 may include a steering wheel, a plurality of operator selectable touch buttons configured to enable the operator to control the operation and function of the work vehicle 100, and any accessories or implements being driven by the powertrain of the work vehicle, including for example the working tool 104.

As used herein, directions with regard to work vehicle 100 may be referred to from the perspective of an operator seated within the operator cab 106; the left of the work vehicle 100 is to the left of such an operator, the right of the work vehicle is to the right of such an operator, a front-end portion (or fore) 112 of the work vehicle 100 is in the direction such an operator faces, a rear-end portion (or aft) 108 of the work vehicle 100 is behind such an operator, a top of the work vehicle 100 is above such an operator, and a bottom of the work vehicle 100 below such an operator.

As illustrated in FIG. 1, the work implement 102 is in a partially lowered, or intermediate, position with respect to the ground surface. The working tool 104 may be adjustable with respect to the boom arm 120 by activation of the cylinder 118 having one end coupled to a portion of the work vehicle 100, as is understood by one skilled in the art, and at another end thereof operatively connected to an implement link 134. The implement link 134 is rotatably coupled to an end of the cylinder 118 at a pivot location 136. Another end of the implement link 134 is rotatably coupled to a portion of the working tool 104 at a pivot location (not shown). An intermediate portion 138 of the implement link 134 is rotatably coupled to a flange 140 fixedly connected to the arm 120. Extension and retraction of the hydraulic cylinder 118 rotates the working tool 104 about the pivot location 142. The hydraulic cylinder 118 and the implement link 134 provide an implement actuator to move the working tool 104 with respect to the boom arm 120.

One or more position sensors 204 (as represented in FIG. 2 but not shown in FIG. 1) may include a kinematic sensor located at or near one or more of the above-referenced pivot locations, for example to determine an angle of rotation of the arm 120 with respect to the frame 112. In one embodiment, a position sensor 204 may be operatively connected to the arm 120 by a four bar linkage as is understood by one skilled in the art. In another embodiment, a position sensor 204 may be located at the pivot location 150. As the hydraulic cylinder 118 extends and retracts, the arm 120 is raised and lowered with respect to the ground surface. Another position sensor 204 may be located at or near a pivot axis of the implement link 134 with respect to the flange 140. As the hydraulic cylinder 118 extends and retracts, the working tool 104 rotates about the axis of pivot location 142. An output of a first position sensor 204 may be used for example to determine a height of the working tool 104 with respect to the ground surface and an output of another position sensor 204 may be used to determine the inclination of the working tool 104 with respect to the arm 120.

One or more imaging devices 202 such as for example stereo cameras may be provided. As illustrated in FIG. 1, a first imaging device 202a is provided at a first (e.g., upper) position on the work vehicle 100 and a second imaging device 202b is provided at a second (e.g., lower) position on the work vehicle 100 and relative to the first imaging device 202a. In various embodiments, only one imaging device 202 is provided, or for example more than two imaging devices (not shown) may be provided for the work vehicle 100 and implemented alongside or substituted for one or more of the first imaging device 202a and the second imaging device 202b within the scope of the present disclosure.

In the embodiment as shown, the first imaging device 202a is located on or proximate to the hydraulic cylinder 118, for example at or proximate to the pivot location 136, and moves relative to the frame 112 of the work vehicle 100 along with movement of the work implement 102. Further in the embodiment as shown, the second imaging device 202b is located on or proximate to an axle of the work vehicle 100 and remains in a fixed position relative to the frame 112 of the work vehicle 100 regardless of relative movement of the work implement 102 thereto.

The first imaging device 202a and the second imaging device 202b may be cameras arranged to capture images corresponding to at least respective fields of view 203a, 203b. Positioning of the upper imaging device 202a on the work implement 102 may generally be preferred over positioning of the upper imaging device 202a on an elevated and static portion of the work vehicle 100 such as for example atop the operator cab 106, at least because the respective field of view from atop the operator cab 106 is only moderately improved over the field of view from within the operator cab 106 itself, and significantly more obscured by the work implement 102 at most if not all stages of the available trajectory of movement thereof. It may however be appreciated that locations for the first imaging device 202a and the second imaging device 202b are not limited to those illustrated in the figures, and various alternatives may be used for the purposes described in more detail below and within the scope of the present disclosure. For example, in an embodiment the lower imaging device 202b may be mounted to a bottom portion of the work implement 102 (e.g., a bucket link mount) such that raising of the work implement 102 presents a field of view 203b, or a third imaging device (not shown) may be mounted to a bottom portion of the work implement 102 (e.g., a bucket link mount) such that raising of the work implement 102 presents an additional field of view for stitching together with field of view 203b when the work implement 102 is sufficiently raised. A fourth imaging device (not shown) may in an embodiment be provided for example on top of the operator cab 106 to present another field of view for stitching together with field of view 203a when the work implement 102 is sufficiently lowered, or for use if for example imaging device 202a becomes non-functional or otherwise unavailable.

Imaging devices 202 may include video cameras configured to record an original image stream and transmit corresponding data to the controller 220. In the alternative or in addition, imaging devices 202 may include one or more of a digital (CCD/CMOS) camera, an infrared camera, a stereoscopic camera, a PMD camera, a time-of-flight/depth sensing camera, high resolution light detection and ranging (LiDAR) scanners, radar detectors, laser scanners, and the like within the scope of the present disclosure. An orientation and/or location of the one or more imaging devices 202 may vary in accordance with the type of work vehicle 100 and relevant applications.

Object detection devices 206 may in various embodiments include the imaging devices 202, supplemental imaging devices, alternative devices including for example radar, lidar, etc. Object detection devices 206, which may also include or otherwise be referenced herein as object sensors or perception sensors, may generally be configured for detecting and/or classifying the surroundings of the work vehicle 100, and various examples of which in addition or alternatively with respect to cameras may include ultrasonic sensors, laser scanners, radar wave transmitters and receivers, thermal sensors, structured light sensors, other optical sensors, and the like. The types and combinations of imaging devices in these contexts may vary for a type of work vehicle, work area, and/or application, but generally may be provided and configured to optimize recognition and classification of a material being loaded and unloaded, and work conditions corresponding to at least these work states, at least in association with a determined working area (loading, unloading, and associated traverse) of the work vehicle 100 for a given application. In some embodiments the object sensors 206 may include the ability to determine an object position as well as an object distance. In other embodiments output signals from one or more object sensors 206 are utilized in combination with output signals from one or more other object signals 206, and/or output signals from one or more imaging devices 202, to determine the position of an object and a corresponding distance between the object and the work vehicle.

In various embodiments, a respective field of vision for each object sensor 206 may overlap with the respective image region 203 for at least one imaging device 202.

In an embodiment, an imaging device 202 may include an ultra-wide-angle lens (e.g., a “fish-eye” lens) having a sufficiently broad field of view to capture an area of interest at any position along an available trajectory of movement (if any) of a component upon which the imaging device 202 is mounted, and to provide image data comprising the area of interest projected on a plane for image data processing functions as further described elsewhere herein. Imaging devices 202 may be provided with a zoom lens such that the field of view 203 and correspondingly the respective output image data compensates, e.g., for movement of the position of the imaging device 202 relative to an object or area of interest. Such an embodiment may eliminate or at least reduce the need for data processing downstream of the imaging device 202 to resize the field of view, for example where the scale of the resultant image may otherwise vary depending on the relative heights of the imaging devices as they transition there between during operation as further described below.

In an embodiment, it may be contemplated that an imaging device 202 is provided with a moveable/rotatable mount such that the corresponding field of view 203 is dynamic to correspond as much as possible with a detected object or area of interest throughout movement of the work vehicle 100 or of a component upon which the imaging device 202 is mounted relative to the frame 112.

One of skill in the art may appreciate that image data processing functions may be performed discretely at a given imaging device 202 if properly configured, but most if not all image data processing may generally be performed by the controller 220 or other downstream data processor. For example, image data from an imaging device 202 may be provided for three-dimensional point cloud generation, image segmentation, object delineation and classification, and the like, using image data processing tools as are known in the art in combination with the objectives disclosed.

With further reference to FIG. 2, the controller 220 may be configured to receive inputs from some or all of various data sources such as imaging devices 202, one or more position sensors 204, object detection sensors 206, and optionally further (not shown) data sources such as onboard payload sensors, onboard work state sensors, and external data sensors such as for example from a remote computing device, the user interface, and/or a machine control system for the work vehicle 100 if separately defined with respect to the controller 220. Hydraulic pressure sensors may provide pressure input indicative of, for example, hydraulic pressure in one side of, e.g., hydraulic cylinder 118 of the work implement 102 assembly. Other sensors providing input to the controller 220 may for example include sensors coupled to piston-cylinder units to detect the relative hydraulically actuated extensions thereof, imaging devices, and/or any known alternatives as may be known to those of skill in the art to provide position or movement input indicative of a position (e.g., angular position or displacement) or movement (e.g., angular velocity or acceleration) of one or more components of the work implement 102 and/or working tool 104.

In an embodiment, position sensors 204 as noted above may include kinematics sensors for tracking a position of the upper imaging device 202a relative to a predetermined area of interest, a relative position of the work implement 102 relative to the frame 112, a component within the work implement 102 relative to another component therein, and/or the like. Kinematics sensors may be provided in the form of inertial measurement units (each, an IMU), which for example include a number of sensors including, but not limited to, accelerometers, which measure (among other things) velocity and acceleration, gyroscopes, which measure (among other things) angular velocity and angular acceleration, and magnetometers, which measure (among other things) strength and direction of a magnetic field. Generally, an accelerometer provides measurements, with respect to (among other things) force due to gravity, while a gyroscope provides measurements, with respect to (among other things) rigid body motion. The magnetometer provides measurements of the strength and the direction of the magnetic field, with respect to (among other things) known internal constants, or with respect to a known, accurately measured magnetic field. The magnetometer provides measurements of a magnetic field to yield information on positional, or angular, orientation of the IMU; similarly to that of the magnetometer, the gyroscope yields information on a positional, or angular, orientation of the IMU. Accordingly, the magnetometer may be used in lieu of the gyroscope, or in combination with the gyroscope, and complementary to the accelerometer, in order to produce local information and coordinates on the position, motion, and orientation of the IMU.

In another embodiment, non-kinematic sensors may be implemented for position detection, such as for example markers or other machine-readable components that are mounted or printed on the work vehicle 100 and within the field of view 203 of an imaging device 202. In one example, April tags or an equivalent may be provided such that, depending on how the marker appears within the field of view 203 of the imaging device 202, data processing elements may calculate a distance to the marker and/or orientation of the marker relative to the imaging device 202 for spatially ascertaining the position of the imaging device 202. As another example, machine learning techniques may be implemented based on inputs for two or more known components of the work vehicle 100 such as a front cab mount and a rear mudguard, such that the data processing units can spatially ascertain a position of the imaging device 202 based on a distance between the two or more components and their respective positions in the field of view 203 of the imaging device 202.

A controller 220 for the above-referenced purposes may be embodied by or include a processor 212 such as a general purpose processor, a digital signal processor (DSP), an application specific integrated circuit (ASIC), a field programmable gate array (FPGA) or other programmable logic device, discrete gate or transistor logic, discrete hardware components, or any combination thereof designed and programmed to perform or cause the performance of the functions described herein. A general-purpose processor can be a microprocessor, but in the alternative, the processor can be a microcontroller, or state machine, combinations of the same, or the like. A processor can also be implemented as a combination of computing devices, e.g., a combination of a DSP and a microprocessor, a plurality of microprocessors, one or more microprocessors in conjunction with a DSP core, or any other such configuration.

The controller 220 may further generate control signals for controlling the operation of respective actuators, or signals for indirect control via intermediate control units, associated with a work vehicle steering control system 224, a work implement control system 226, and/or a work vehicle drive control system 228. The controller 220 may for example generate control signals for controlling the operation of various actuators, such as hydraulic motors or hydraulic piston-cylinder units, and electronic control signals from the controller 220 may actually be received by electro-hydraulic control valves associated with the actuators such that the electro-hydraulic control valves will control the flow of hydraulic fluid to and from the respective hydraulic actuators to control the actuation thereof in response to the control signal from the controller 220.

The controller 220 further communicatively coupled to a hydraulic system as work implement control system 226 may accordingly be configured to operate the work vehicle 100 and operate a work implement 102 coupled thereto, including, without limitation, a lift mechanism, tilt mechanism, roll mechanism, pitch mechanism and/or auxiliary mechanisms, for example and as relevant for a given type of work implement or work vehicle application.

The controller 220 further communicatively coupled to a hydraulic system as steering control system 224 and/or drive control system 228 may be configured for moving the work vehicle 100 in forward and reverse directions, moving the work vehicle left and right, controlling the speed of the work vehicle's travel, etc. The drive control system 228 may be embodied as, or otherwise include, any device or collection of devices (e.g., one or more engine(s), powerplant(s), or the like) capable of supplying rotational power to a drivetrain and other components, as the case may be, to drive operation of those components. The drivetrain may be part of the drive control system 228 or may for example be embodied as, or otherwise include, any device or collection of devices (e.g., one or more transmission(s), differential(s), axle(s), or the like) capable of transmitting rotational power provided by the drive control system 228 to the ground engaging units 110, 114 to drive movement of the work vehicle 100.

The controller 220 may include, in addition to the processor 212, a computer readable medium 214, a communication unit 216, data storage 218 such as for example being or otherwise including a database network, and the aforementioned user interface 116 or control panel having a display 210. It may be understood that the controller 220 described herein may be a single controller having all of the described functionality, or it may include multiple controllers wherein the described functionality is distributed among the multiple controllers.

Various operations, steps or algorithms as described in connection with the controller 220 can be embodied directly in hardware, in a computer program product such as a software module executed by the processor 212, or in a combination of the two. The computer program product can reside in RAM memory, flash memory, ROM memory, EPROM memory, EEPROM memory, registers, hard disk, a removable disk, or any other form of computer-readable medium 220 known in the art. An exemplary computer-readable medium 214 can be coupled to the processor 212 such that the processor 212 can read information from, and write information to, the memory/storage medium 218. In the alternative, the medium 218 can be integral to the processor 212.

The communication unit 216 may support or provide communications between the controller 220 and external systems or devices, for example via a wireless communications network, and/or support or provide communication interface with respect to internal components of the work vehicle 100. The communications unit may include wireless communication system components (e.g., via cellular modem, WiFi, Bluetooth or the like) and/or may include one or more wired communications terminals such as universal serial bus ports.

The data storage 218 as discussed herein may, unless otherwise stated, generally encompass hardware such as volatile or non-volatile storage devices, drives, memory, or other storage media, as well as one or more databases residing thereon. The data storage 218 may for example have stored thereon image data from each imaging device 202, position data from at least the position sensors 204, object data from at least the object detection sensors 206, and one or more models developed for correlating any of the relevant data with respect to for example work states, object states, intervention states, areas of interest, obstructions to the fields of view for respective imaging devices relative to an area of interest, etc. Data storage 218 may in some embodiments include data storage physically located elsewhere from the work vehicle 100 and controller 220 and can include any cache memory in a processing device, as well as any storage capacity used as a virtual memory, e.g., as stored on a mass storage device or another computer coupled to the controller 220. The mass storage device can include a cache or other dataspace which can include databases. Data storage, in other embodiments, is located in the “cloud”, wherein for example memory is located at a distant location which provides the stored information wirelessly to the controller 220.

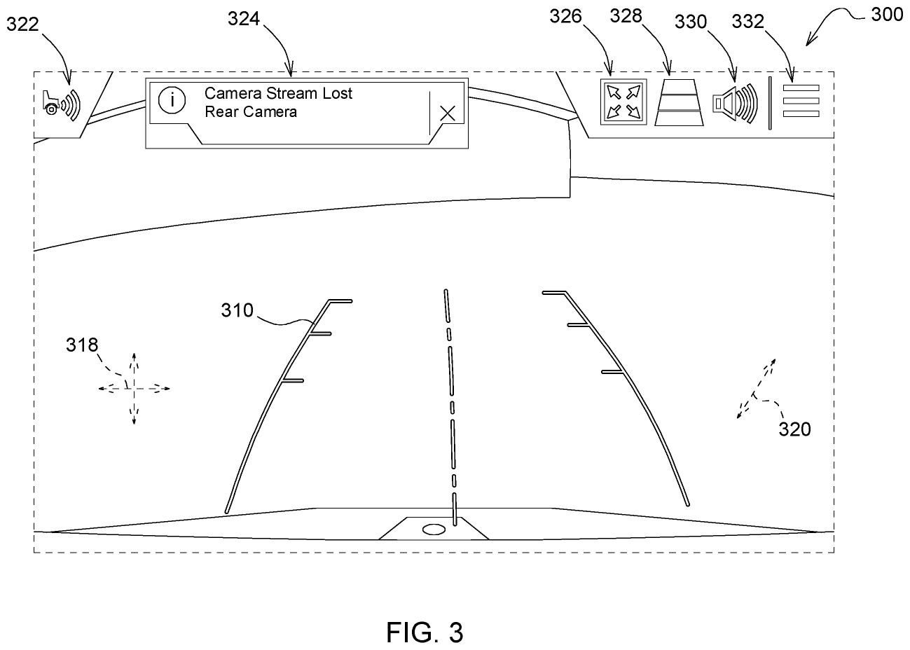

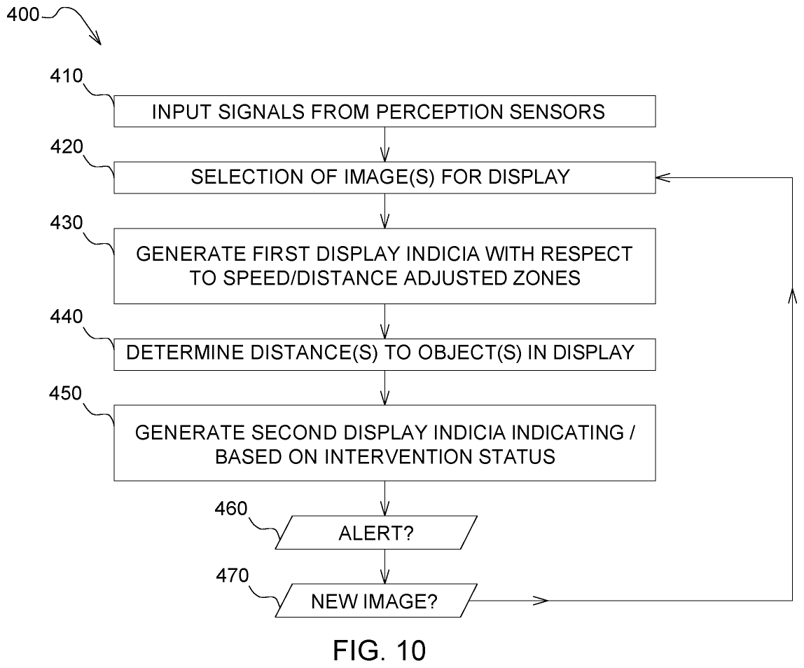

Referring now to FIGS. 3-10 for illustrative purposes, an embodiment of a method 400 according to the present disclosure may now be described regarding dynamically adjusting alerts based on detected objects external to a work vehicle, for example with respect to a work vehicle 100 as described above. While an embodiment as discussed herein and with reference to the illustrated work vehicle 100 in FIG. 1 may typically represent objects and associated alerts in displayed areas of interest forward of the work vehicle, in other embodiments for example utilizing alternative work vehicles the area of interest may be in other directions.

The method 400 may for example be executed by the above-referenced controller 220, alone or in at least partial combination with separate components of a vehicle or machine control unit, mobile user devices, and/or distributed computing elements such as for example in a cloud computing environment.

The illustrated method 400 may begin with a step 410 inputting or otherwise obtaining input signals from various perception sensors or other sensors relating to the position, orientation, and/or surroundings of the work vehicle, such as for example sensors 202, 204, 206 as described above.

In another step 420, the method 400 includes selecting one or more images for display to an operator or other user associated with the work vehicle. In an embodiment, the displayed image may be associated with a camera directed to a predetermined area of interest, e.g., directed to an area in front of the work vehicle at least while the work vehicle is proceeding in a forward direction.

Alternatively, the displayed image may be associated with a camera that is determined based on user input, for example by receiving input signals from the user interface which identify a camera, an area around the work vehicle, a direction relative to the work vehicle, a particular object detected relative to the work vehicle, etc.

In an embodiment, the displayed image may be dynamically determined based on detection of an object within a specified range of the work vehicle and within the field of view of an associated camera. For example, a first image may be displayed during “normal” operation, but the display unit may be dynamically switched to display of a second image when an object is detected within the field of view of a camera associated with the second image.

In an embodiment, the displayed image may be determined at least in part based on a determined work state for the work vehicle. For example, a first image may be displayed during a work state associated with forward movement of the work vehicle, whereas a second image may be displayed during a work state associated with backward movement of the work vehicle, and further whereas a third image may be displayed during a work state associated with certain movements of a work implement for the work vehicle. The relevant work state may be determined based at least in part on work vehicle operating parameters such as travel speed or engine torque, user-initiated commands, and/or detected positions and/or orientations of the work vehicle frame, the work implement, the working tool, and/or the like. As one example, it may be determined that a current or predicted work state corresponds to loading of material from the ground surface within a bucket as the working tool, or picking up a pallet on the ground with forks as the working tool, wherein the area of interest may be directed to a corresponding region at ground level and in front of the work vehicle 100. As another example, it may be determined that a current or predicted work state corresponds to unloading of material from within the bucket into a container having an elevated rim, or depositing a pallet onto an elevated surface of a flatbed transport vehicle, wherein the area of interest may be directed to a corresponding region at a specified elevation above ground level and in front of the work vehicle 100. Other examples may of course be relevant based on the type of work vehicle, the type of work implement or working tool attached thereto, etc.

In various embodiments as described above, the selection of an image for display may include selective repositioning of a single camera to obtain a different selected image for display relative to an original image for display. In other words, rather than switching from a first image provided via a first camera to a second image provided via a second camera, the first camera may itself be repositioned or otherwise modified to switch from a first image output to a second image output based for example on a detected object within the field of view of the first camera, or image processing may be performed to zoom in on or otherwise switch from a first display to a second display within the same field of view associated with the same first camera.

In another step 430, the method 400 may include generating first display indicia 310 with respect to one or more zones that extend concentrically from a point associated with the work vehicle 100 and are adjusted in size, orientation, coloration, and the like according to a current or predicted speed of the work vehicle, distance from the work vehicle, trajectory of the work vehicle, etc. In an exemplary embodiment as illustrated in FIG. 3, the first display indicia 310 includes lines 310 superimposed over the underlying display image 300 and extending away from the work vehicle according to a current trajectory. The lines 310 may for example be generated approximately representing a path of each respective tire or track of the work vehicle. Additional markings may be provided, for example as illustrated in FIG. 3 as tabs or short lines extending inward from the lines 310 and substantially perpendicular thereto, to define a plurality of zones 312, 314, 316.

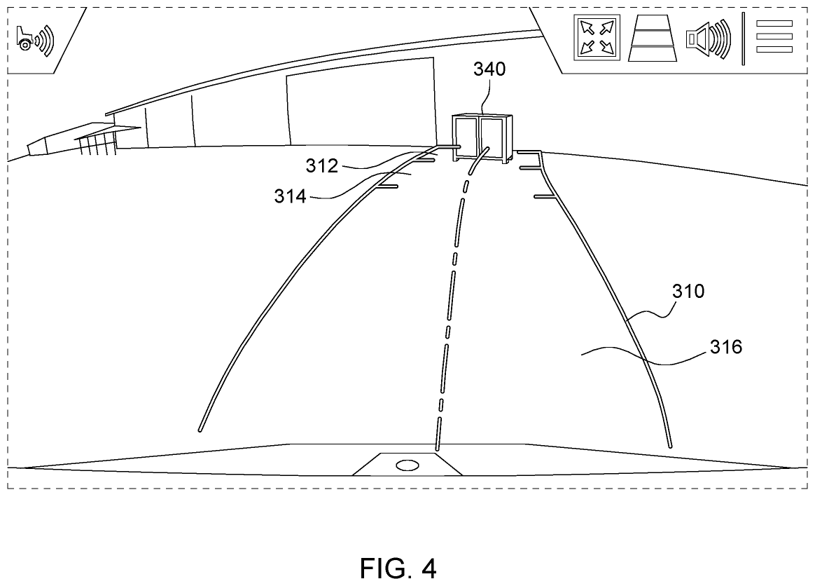

One or more of the concentric zones 312, 314, 316 may be generated with sizes relative to the travel speed of the work vehicle, such that the zones 312, 314, 316 visually shrink or expand with respect to corresponding changes in the travel speed of the work vehicle. For example, at least the nearest zone 316 in FIG. 3 is relatively short in response to a slower travel speed of the work vehicle, whereas at least the nearest zone 316 in FIG. 4 is relatively long in response to a faster travel speed of the work vehicle. In some embodiments, all of the zones may visually shrink or expand in size together, for example in linear fashion with respect to changes in travel speed of the work vehicle. In other embodiments, one or more of the zones may be dynamically adjusted non-linearly and/or substantially independently of other zones in response to changes in travel speed of the work vehicle.

In some embodiments, one or more of the zones 312, 314, 316 may have sizes determined according to other parameters and dependent on a current type of work vehicle, work implement, work area, working condition, and the like. For example, conditions associated with lower visibility or certainty with respect to identifying objects in the field of view, or lower control of the work vehicle such as for example slippage, or work vehicles having particularly dangerous work implement extensions, may result in longer zones.

In the exemplary embodiment represented in FIG. 3 the display area may, in addition to the display image 300 from at least one of the cameras and the superimposed first display indicia 310, include a number of additional user interface tools. A panning tool 318 and/or a zoom tool 320 may enable user-selective transition of the display view, whether within a field of view for one camera, transitioning from one camera to another camera, or a combination thereof. A status indicator 322 and/or notifications bar 324 may dynamically indicate changes in operating conditions, status of communications with sensors, presence of objects within a threshold number of zones from the work vehicle, and/or the like. A reset view tab 326 may user-selectively enable the current display view to be reset to a previous or default view.

User-selectable working conditions may be specified as well, wherein the system may be configured to define the sizes of one or more zones, the thresholds for alerts, and the like based at least in part thereon. For example, user selection of a tight space mode tab 328, or various settings in a selectable menu tab 332 as illustrated. Such settings may include user selectable options for form or characteristics of the first display indicia 310 and/or the second display indicia 340, whether or not zones are to be shaded upon detection of an object therein, whether or not potentially moving objects are to be bounded (as further described below), and the like. A mute tab 330 or button may be provided for silencing or enabling of audio alerts.

The method 400 may further include a step 440 of determining relative distances of detected objects within the display image 300 from the work vehicle. Detection and classification of objects in a field of view, and calculation of distances to the respective objects, may be performed using object detection systems as are known in the art. Preferably, object detection sensors 206 and the controller 220 are not only able to accurately detect the presence or absence of an object in the (actual or projected) working path of the work vehicle, but also to distinguish between different types of objects (e.g., people, other vehicles, static elements) and provide appropriate feedback.

In another step 450, the method 400 may include generating second display indicia, for example superimposed upon or otherwise displayed alongside the first display indicia 310, indicating or based on an intervention status for detected objects within the display image 300. The intervention status may be determined based on the detected distance, and in view of the travel speed of the work vehicle. The intervention status may further be determined in view of a work state of the work vehicle.

For example, while the current travel speed and trajectory of the work vehicle may otherwise indicate a potential for collision with the detected object in a period of time that would result in an intervention status corresponding to an operator alert, the controller 220 may determine that the current travel speed and/or trajectory will not be maintained based on the work state, and therefore at least provisionally calculate a different intervention status.

In various embodiments the controller 220 may make this determination based on predetermined rules, such that for example the thresholds are fixed with respect to different work states, or the controller 220 may learn correlations over time between the determined work state and patterns of travel for the work vehicle which leads to confidence in the predicted movements of the work vehicle and associated work implement. This may for example avoid false positives with respect to generated visual and audio alerts.

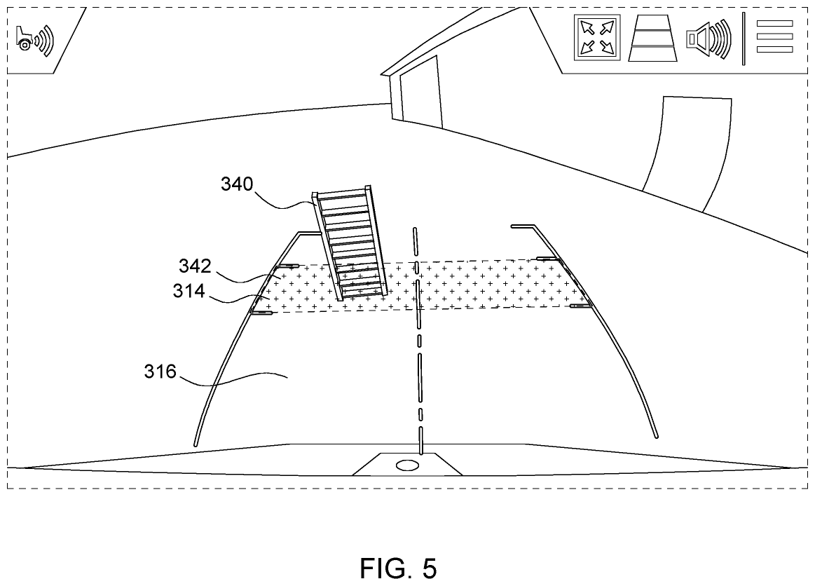

As represented in FIG. 4, an object 340 has been detected and identified as being in the farthest zone 312, and second display indicia (in this case, coloring or shading which may be dependent on the associated intervention status) 342 has been displayed over the underlying image within the zone 312. In contrast, as represented in FIG. 5, an object 340 has been detected and identified as being in a second zone 314, or an intermediate zone in this context, and second display indicia 342 has been displayed over the underlying image within the zone 314.

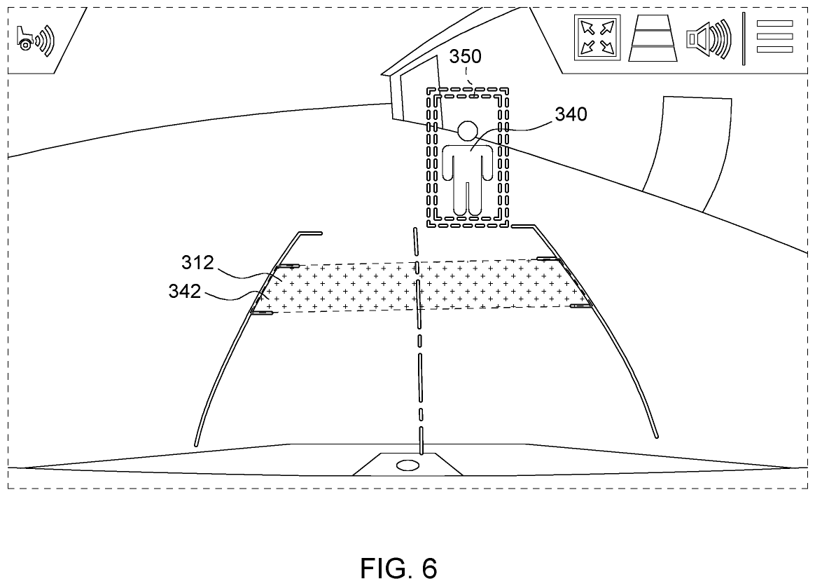

In both of FIGS. 4 and 5, the detected object 340 is reasonably classified as being of a first type that is static in nature, such that a degree of certainty is inferred regarding potential movement of the object 340. As illustrated in FIGS. 6-8, the detected “object” 340 may alternatively be classified as being of a second type with the potential to move independently of the work vehicle, in this case a bystander standing in the farthest generated zone 312. In addition to generating second display indicia 342 in association with the detected object 340, which may for example be determined based on an intervention status that accounts for the potential movement and any associated uncertainty, the system may further generate visual indicia 350 indicating for example that the detected object 340 is a bystander. The visual indicia 350 may correspond to a bounded region around the detected object 340, and may further account for priority levels based in part on proximity and/or previously observed movements of the detected object, in addition to the detection type.

The method 400 may further include generating alerts based on the determined intervention state (step 460). Generally stated, a detected object 340 of a first distance from the work vehicle may result in an alert of a first type if the work vehicle is moving slowly, whereas the same object and distance may result in an alert of a second type if the work vehicle is moving more rapidly, and/or for example in relatively unstable work conditions. Likewise, at a first travel speed, a detected object 340 of a first distance from the work vehicle may result in an alert of a first type, whereas the same object and travel speed may result in an alert of a second type if the detected object is at a second distance.

In various embodiments, different levels of alerts may be generated based on different levels or types of intervention states. For example, different levels of audio and/or visual alerts may correspond to proximity of the relevant zone for a detected object. Different levels of audio and/or visual alerts may be generated based on different detection types (e.g., static versus bystander). Certain levels of alerts may be muted or otherwise disabled respective of other levels of alerts, which may for example be predetermined, automated for certain work states or working conditions, or otherwise manually selectable by a user associated with the work vehicle. Effectively, whether or not an alert (or a particular level of alert) is generated may vary according to travel speed, time to collision or otherwise engagement with the detected object, stopping distance for the work vehicle, stopping time for the work vehicle, predicted movement of the detected object with respect to a trajectory of the work vehicle, and the like, as demonstrated at least in part through the generated visual zones and display indicia.

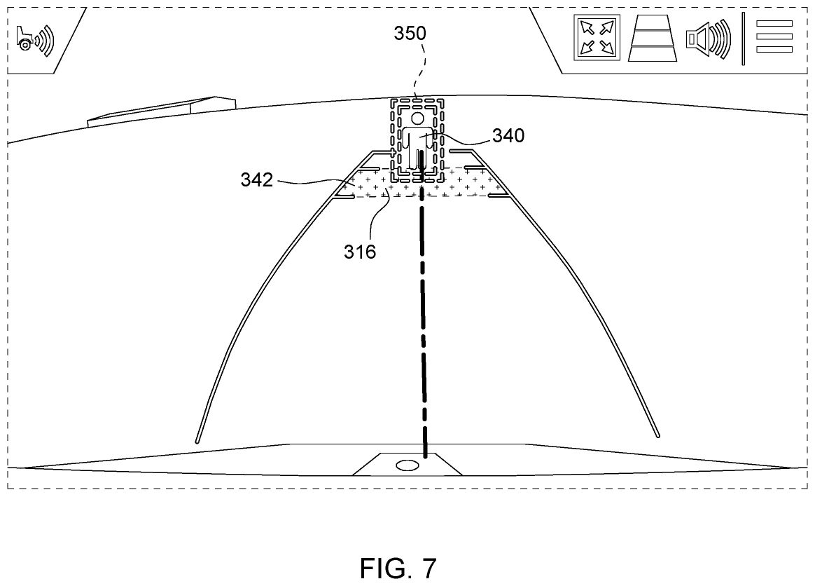

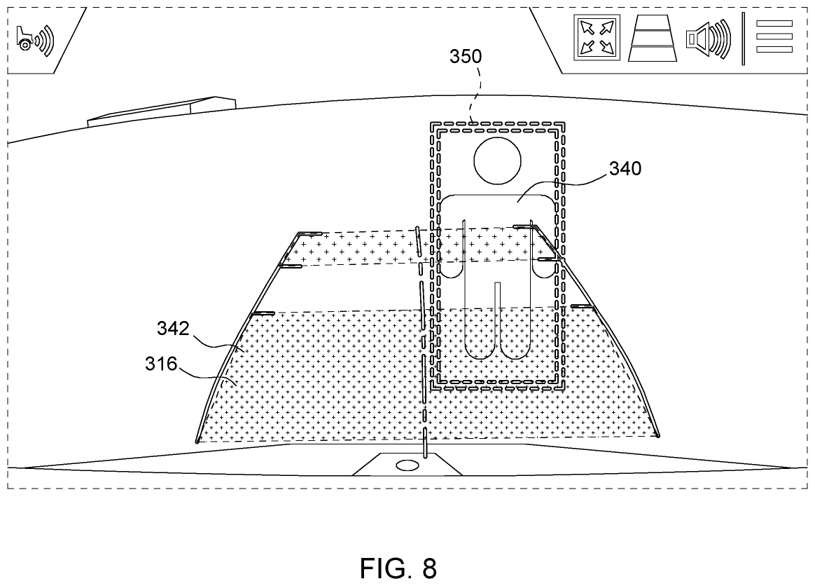

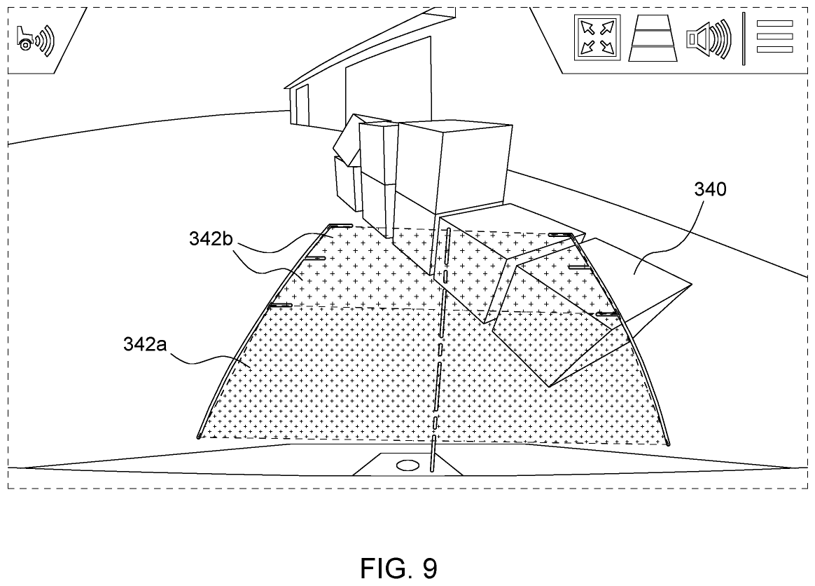

In one example of a visual alert, which may or may not be provided alongside an audio alert, FIG. 8 illustrates a change in the color, shading, or other visual characteristic in the second display indicia 342 for a detected object 340 in the nearest zone 316, in contrast to the second display indicia 342 for a similar detected object 340 in the intermediate zone 314 (as illustrated in FIG. 7) or the farthest zone 312 (as illustrated in FIG. 6). As further illustrated in FIG. 9, different second display indicia 342a, 342b may be generated to account for one or more detected objects 340 that reside in or across different zones, with the different second display indicia 342a, 342b representing alerts for the viewing user corresponding for example to proximity with the work vehicle.

In an embodiment, alerts may (in addition to or instead of audio and/or visual alerts) include output signals to an automated control feature associated with the work vehicle. For example, the controller 220 may in association with a particular intervention state generate control signals to the steering control unit 224, implement control unit 226, and/or drive control unit 228, for automatically steering away from a detected object, automatically braking to avoid colliding with the detected object, etc. In an embodiment, automated control features may be implemented after a predetermined window after an initial alert is generated, wherein the operator or other user associated with the work vehicle has an opportunity to react to the alert but has not yet acted, but before a threshold which may correspond to a necessary amount of time for reacting to the detected object (e.g., a calculated stopping time, calculated stopping distance, predicted movement of the detected object, etc., further possibly accounting for determined work conditions).

In an embodiment, the method 400 may continuously determine whether a different image should be displayed (step 470), based for example on objects that are detected in fields of view for respective cameras other than a current camera being utilized, or a detected or predicted change in trajectory of the work vehicle, for example. The user may further for example be empowered via the user interface to select individual cameras, exclude individual cameras from selection, toggle between cameras, identify a particular camera associated with a current display image 300, etc. Upon selection of a new image and return to step 420, whether automatically or manually initiated, the method 400 may continue with the following steps.

Those having ordinary skill in the art will recognize that terms such as “above,” “below,” “upward,” “downward,” “top,” “bottom,” etc., are used descriptively for the figures, and do not represent limitations on the scope of the present disclosure, as defined by the appended claims.

Terms of degree, such as “generally,” “substantially,” or “approximately” are understood by those having ordinary skill in the art to refer to reasonable ranges outside of a given value or orientation, for example, general tolerances or positional relationships associated with manufacturing, assembly, and use of the described implementations.

As used herein, “e.g.” is utilized to non-exhaustively list examples and carries the same meaning as alternative illustrative phrases such as “including,” “including, but not limited to,” and “including without limitation.” Unless otherwise limited or modified, lists with elements that are separated by conjunctive terms (e.g., “and”) and that are also preceded by the phrase “one or more of” or “at least one of” indicate configurations or arrangements that potentially include individual elements of the list, or any combination thereof. For example, “at least one of A, B, and C” or “one or more of A, B, and C” indicates the possibilities of only A, only B, only C, or any combination of two or more of A, B, and C (e.g., A and B; B and C; A and C; or A, B, and C).

Thus it is seen that systems, work vehicles, and/or methods according to the present disclosure readily achieve the ends and advantages mentioned as well as those inherent therein. While certain preferred embodiments of the disclosure have been illustrated and described for present purposes, numerous changes in the arrangement and construction of parts and steps may be made by those skilled in the art, which changes are encompassed within the scope and spirit of the present disclosure as defined by the appended claims. Each disclosed feature or embodiment may be combined with any of the other disclosed features or embodiments, unless otherwise specifically stated.

What is claimed is:

1. A method for dynamically adjusting alerts based on detected objects external to a work vehicle, the method comprising:
generating object signals from one or more of a plurality of vehicle-mounted object sensors, the object signals representative of detected objects in a respective field of vision;
selectively generating images on a display unit, the generated images corresponding to a respective image region for each of a plurality of vehicle-mounted cameras, wherein the respective field of vision for each of the plurality of object sensors overlaps with the image region for at least one of the plurality of cameras;
displaying first indicia with respect to the selectively generated images, defining or based at least in part on one or more concentric zones that are dynamically configured based on at least one operating characteristic of the work vehicle;
for each generated image, determining a distance to any one or more detected objects in the respective field of vision; and
displaying second indicia with respect to the selectively generated images, wherein the displayed second indicia correspond to a respective intervention state for the any one or more of the detected objects in the respective field of vision and further within the selectively generated images, the respective intervention state determined based on at least the determined distance and at least one operating characteristic of the work vehicle.

2. The method of claim 1, wherein the at least one operating characteristic of the work vehicle comprises a travelling speed of the work vehicle.

3. The method of claim 1, wherein the at least one operating characteristic of the work vehicle comprises a movement of a work implement moveable independently with respect to a frame of the work vehicle.

4. The method of claim 1, wherein the at least one operating characteristic of the work vehicle comprises an estimated stopping distance and/or stopping time.

5. The method of claim 1, wherein the respective intervention state corresponds to an estimated time to engagement by the work vehicle with the respective detected object based on the at least determined distance and the at least one operating characteristic of the work vehicle.

6. The method of claim 5, wherein the respective intervention state corresponds to an estimated time to engagement by the work vehicle with the respective detected object further based on a potential movement state of the respective detected object.

7. The method of claim 6, wherein the respective intervention state corresponds to an estimated time to engagement by the work vehicle with the respective detected object further based on a detected movement and/or predicted future position of the respective detected object.

8. The method of claim 6, wherein the displayed second indicia comprises a bounded area about the respective detected object based on the potential movement state thereof.

9. The method of claim 5, wherein the respective intervention state further corresponds to a predicted response in the at least one operating characteristic of the work vehicle.

10. The method of claim 1, further comprising generating control signals to one or more actuators for adjusting the at least one operating characteristic of the work vehicle based on at least the respective intervention state.

11. The method of claim 1, wherein the displayed first indicia comprise a plurality of concentric zones, each of which are independently configured based on the at least one operating characteristic.

12. The method of claim 11, wherein each of the plurality of concentric zones are non-linearly scaled with respect to others of the plurality of concentric zones based on changes in travelling speed of the work vehicle over time.

13. A work vehicle comprising:
a plurality of vehicle-mounted object sensors each configured to generate object signals representative of detected objects in a respective field of vision;
a plurality of vehicle-mounted cameras each configured to generate image data corresponding to a respective image region, wherein the respective field of vision for each of the plurality of object sensors overlaps with the image region for at least one of the plurality of cameras; and
a controller linked to receive the generated object signals and the generated image data, and configured to
selectively generate images on a display unit based on the received image data,
display first indicia with respect to the selectively generated images, defining or based at least in part on one or more concentric zones that are dynamically configured based on at least one operating characteristic of the work vehicle,
for each generated image, determine a distance to any one or more detected objects in the respective field of vision, and
display second indicia with respect to the selectively generated images, wherein the displayed second indicia correspond to a respective intervention state for the any one or more of the detected objects in the respective field of vision and further within the selectively generated images, the respective intervention state determined based on at least the determined distance and the at least one operating characteristic of the work vehicle.

14. The work vehicle of claim 13, wherein the respective intervention state corresponds to an estimated time to engagement by the work vehicle with the respective detected object based on the at least determined distance and the at least one operating characteristic of the work vehicle.

15. The work vehicle of claim 14, wherein the respective intervention state corresponds to an estimated time to engagement by the work vehicle with the respective detected object further based on a potential movement state of the respective detected object.

16. The work vehicle of claim 15, wherein the displayed second indicia comprises a bounded area about the respective detected object based on the potential movement state thereof.

17. The work vehicle of claim 13, wherein the controller is further configured to generate control signals to one or more actuators for adjusting the at least one operating characteristic of the work vehicle based on at least the respective intervention state.

18. A system for dynamically adjusting alerts based on detected objects external to a work vehicle, the system comprising:
one or more processors communicatively linked to a plurality of vehicle-mounted object sensors each configured to generate object signals representative of detected objects in a respective field of vision, and to a plurality of vehicle-mounted cameras each configured to generate image data corresponding to a respective image region, wherein the respective field of vision for each of the plurality of object sensors overlaps with the image region for at least one of the plurality of cameras;
wherein the one or more processors are configured to
selectively generate images on a display unit based on the received image data,
display first indicia with respect to the selectively generated images, defining or based at least in part on one or more concentric zones that are dynamically configured based on at least one operating characteristic of the work vehicle,
for each generated image, determine a distance to any one or more detected objects in the respective field of vision, and
display second indicia with respect to the selectively generated images, wherein the displayed second indicia correspond to a respective intervention state for the any one or more of the detected objects in the respective field of vision and further within the selectively generated images, the respective intervention state determined based on at least the determined distance and the at least one operating characteristic of the work vehicle.

19. The system of claim 18, wherein the respective intervention state corresponds to an estimated time to engagement by the work vehicle with the respective detected object based on the at least determined distance and the at least one operating characteristic of the work vehicle.

20. The system of claim 18, wherein the respective intervention state corresponds to an estimated time to engagement by the work vehicle with the respective detected object further based on a potential movement state of the respective detected object.
